(19) United States
(12) Patent Application Publication
(10) Pub. No.: US 2023/0279209 A1
(43) Pub. Date: Sep. 7, 2023

(54) SOFT AND FLEXIBLE POLYOLEFIN COMPOSITION

(71) Applicant: Basell Poliolefine Italia S.r.l., Milan (IT)

(72) Inventors: Michele Grazzi, Ferrara (IT); Claudio Cavalieri, Ferrara (IT)

(73) Assignee: Basell Poliolefine Italia S.r.l., Milan (IT)

(21) Appl. No.: 18/019,907

(22) PCT Filed: Jul. 1, 2021
(86) PCT No.: PCT/EP2021/068180

§ 371 Date: Feb. 6, 2023

(30) Foreign Application Priority Data
Aug. 7, 2020 (EP) 20189984.6

(51) Int. Cl. C08L 23/14; B29C 48/00; D03D 15/283; D04H 1/4291

(52) U.S. Cl. CPC C08L 23/142; B29C 48/022; D03D 15/283; D04H 1/4291; B29K 2023/14

(57) ABSTRACT

A polyolefin composition made from or containing:
(A) 10-40% by weight of a copolymer of propylene with hexene-1, is made from or containing 1.0-6.0% by weight, based on the weight of (A), of units deriving from hexene-1 and has a melt flow rate (MFR_{A}) measured according to ISO 1133, 230° C., 2.16 kg ranging from 20 to 60 g/10 min.; and
(B) 60-90% by weight of a copolymer of propylene with an alpha-olefin of formula CH₂═CHR, and optionally a diene, wherein R is H or a linear or branched C₂-C₈ alkyl and wherein the copolymer is made from or containing 20-35% by weight, based on the total weight of (B), of alpha-olefin,
   wherein
   the polyolefin composition has an amount of fraction soluble in xylene (XS(tot)) at 25° C. equal to or higher than 65% by weight, and
   the amounts of (A), (B), and XS(tot) being based on the total weight of (A)+(B).

### FIELD OF THE INVENTION

In general, the present disclosure relates to the field of chemistry. More specifically, the present disclosure relates to polymer chemistry. In particular, the present disclosure relates to thermoplastic polyolefin compositions and sheets or membranes made therefrom.

### BACKGROUND OF THE INVENTION

In some instances, elastomers and thermoplastic polyolefins (TPOs) are used to produce sheets and membranes for single ply roofing.

In some instances, polyvinyl chloride (PVC) and other chlorinated TPOs were used to prepare heat-weldable thermoplastic roofing sheets. In those instances, plasticizers were used in PVC formulations to provide flexibility for roofing applications. The aging of membranes through the loss of plasticizers and the presence of chlorine in the polymer chains drove the substitution of PVC with chlorine-free thermoplastic polyolefins having mechanical properties for use in roofing sheets in absence of plasticizers.

In some instances, heterophasic polyolefin compositions are used to prepare sheets or membranes for roofing applications, the compositions being heat-weldable, flexible, and recyclable.

### SUMMARY OF THE INVENTION

In a general embodiment, the present disclosure provides a polyolefin composition made from or containing:
(A) 10-40% by weight of a copolymer of propylene with hexene-1, is made from or containing1.0-6.0% by weight, based on the weight of (A), of units deriving from hexene-1 and has a melt flow rate (MFR_{A}) measured according to ISO 1133, 230° C., 2.16 kg ranging from 20 to 60 g/10 min.; and
(B) 60-90% by weight of a copolymer of propylene with an alpha-olefin of formula CH₂═CHR, and optionally a diene, wherein R is H or a linear or branched C₂-C₈ alkyl and wherein the copolymer is made from or containing 20-35% by weight, based on the total weight of (B), of alpha-olefin,
   wherein
   the polyolefin composition has an amount of fraction soluble in xylene (XS(tot)) at 25° C. equal to or higher than 65% by weight, and
   the amounts of (A), (B), and XS(tot) being based on the total weight of (A)+(B).

In some embodiments, the present disclosure also provides a sheet or membrane made from or containing a polyolefin composition made from or containing:
(A) 10-40% by weight of a copolymer of propylene with hexene-1, is made from or containing1.0-6.0% by weight, based on the weight of (A), of units deriving from hexene-1 and has a melt flow rate (MFR_{A}) measured according to ISO 1133, 230° C., 2.16 kg ranging from 20 to 60 g/10 min.; and
(B) 60-90% by weight of a copolymer of propylene with an alpha-olefin of formula CH₂═CHR, and optionally a diene, wherein R is H or a linear or branched C₂-C₈ alkyl and wherein the copolymer is made from or containing 20-35% by weight, based on the total weight of (B) of alpha-olefin,
   wherein
   the polyolefin composition has an amount of fraction soluble in xylene (XS(tot)) at 25° C. equal to or higher than 65% by weight, and
   the amounts of (A), (B), and XS(tot) being based on the total weight of (A)+(B).

While multiple embodiments are disclosed, other embodiments will become apparent to those skilled in the art from the following detailed description. As will be apparent, certain embodiments, as disclosed herein, are capable of modifications in various aspects, without departing from the spirit and scope of the claims as presented herein. Accordingly, the following detailed description is to be regarded as illustrative in nature and not restrictive.

### DETAILED DESCRIPTION OF THE INVENTION

In some embodiments, the propylene copolymer (A) is made from or containing 2.0-5.0% by weight, alternatively 2.8-4.8% by weight, alternatively 3.0-4.0% by weight, of hexene-1, the amount of hexene-1 being based on the weight of component (A).

In some embodiments, the propylene copolymer (A) is further made from or containing 0.1-3.0% by weight, based on the weight of component (A), of an alpha-olefin selected from the group consisting of ethylene, butene-1, 4-methyl-1-pentene, octene-1, and combinations thereof.

In some embodiments, the propylene copolymer (A) has a melt flow rate (MFR_{A}) measured according to ISO 1133, 230° C., 2.16 kg ranging from 25 to 55 g/10 min., alternatively from 30 to 50 g/10 min.

In some embodiments, the propylene copolymer (A) has an amount of fraction soluble in xylene at 25° C. (XS_{A}) lower than 12.0% by weight, based on the weight of component (A), alternatively lower than 9.0% by weight, alternatively in the range 5.0-12.0% by weight, alternatively 6.0-9.0% by weight, alternatively 6.0-8.0% by weight.

In some embodiments, the propylene copolymer (B) has an amount of fraction soluble in xylene at 25° C. (XS_{B}) higher than 80% by weight, based on the total weight of component (B), alternatively higher than 85% by weight, alternatively higher than 90% by weight.

In some embodiments, the upper limit of the amount of the fraction of component (B) soluble in xylene at 25° C. (XS_{B}) is 97% by weight, based on the total weight of component (B), for each lower limit.

In some embodiments, the component (B) is made from or containing a first copolymer (B1) and a second copolymer (B2) of propylene with an alpha-olefin of formula CH₂═CHR, and optionally a diene, wherein R is H or a linear or branched C₂-C₈ alkyl, provided that the total amount of alpha-olefin in the propylene copolymer (B) is 20-35% by weight, based on the total weight of component (B).

In some embodiments, the component (B) is made from or containing:
(B1) 30-60% by weight, alternatively 40-55% by weight, of a first copolymer of propylene with an alpha-olefin of formula CH₂═CHR, and optionally a diene, wherein R is H or a linear or branched C₂-C₈ alkyl, and wherein the first propylene copolymer is made from or containing 20-40% by weight, alternatively 25-35% by weight, of alpha-olefin and has a fraction soluble in xylene at 25° C. (XS_{B1}) higher than 80% by weight, alternatively higher than 85% by weight, alternatively higher than 90% by weight, the amount of alpha-olefin and of XS_{B1} are based on the weight of component (B1); and
(B2) 40-70% by weight, alternatively 45-60% by weight, of a second copolymer of propylene with an alpha-olefin of formula CH₂═CHR, and optionally a diene, wherein R is H or a linear or branched C₂-C₈ alkyl, and wherein the second propylene copolymer is made from or containing 25-45% by weight, alternatively 30-43% by weight, of alpha-olefin and has a fraction soluble in xylene at 25° C. (XS_{B2}) higher than 80% by weight, alternatively higher than 85% by weight, alternatively higher than 90% by weight, the amount of alpha-olefin and of XS_{B2} are based on the weight of component (B2),
   wherein the amounts of (B1) and (B2) are based on the total weight of the component (B).

In some embodiments, the upper limit of the amount of the fraction of component (B1) or of the component (B2) soluble in xylene at 25° C. (XS_{B1} or XS_{B2}) is 97% by weight for each lower limit, the amounts of XS_{B1} and XS_{B2} being based on the weight of component (B1) and (B2), respectively.

In some embodiments, the upper limit of XS_{B1} and of XS_{B2} is 97% by weight for each lower limit, the amounts of XS_{B1} and XS_{B2} being based on the weight of component (B1) and (B2), respectively.

In some embodiments, the alpha-olefin of components (B), (B1), and (B2) is independently selected from the group consisting of ethylene, butene-1, hexene-1, 4-methy-pentene-1, octene-1, and combinations thereof. In some embodiments, the alpha-olefin is ethylene.

In some embodiments, the propylene copolymers (B), (B1), or (B2) are made from or containing recurring units derived from a diene. In some embodiments, the dienes are independently selected from the group consisting of butadiene, 1,4-hexadiene, 1,5-hexadiene, ethylidene-1-norbonene, and combinations thereof.

In some embodiments, the total amount of recurring units deriving from a diene in the propylene copolymer (B), (B1), or (B2) ranges from 1 to 10% by weight, based on the weight of the relevant component.

In some embodiments, the polyolefin composition has an amount of fraction soluble in xylene (XS(tot)) at 25° C. higher than 70% by weight, based on the total weight of (A)+(B), alternatively from 71 to 90% by weight, alternatively from 72 to 80% by weight.

In some embodiments, the polyolefin composition has a melt flow rate (MFR) measured according to ISO 1133, 230° C., 2.16 kg ranging from 0.2 to 6.0 g/10 min., alternatively from 0.2 to 2.0 g/10 min., alternatively from 0.2 to 1.5 g/10 min., alternatively from 0.25 to 1.00 g/10 min.

In some embodiments, the melt flow rate (MFR) of the polyolefin composition measured according to ISO 1133, 230° C., 2.16 kg ranging from 0.2 to 6.0 g/10 min., alternatively from 0.2 to 2.0 g/10 min., alternatively from 0.2 to 1.5 g/10 min., alternatively from 0.25 to 1.00 g/10 min., is obtained directly from polymerization.

In some embodiments, the melt flow rate (MFR) of the polyolefin composition measured according to ISO 1133, 230° C., 2.16 kg ranging from 0.2 to 6.0 g/10 min., alternatively from 0.2 to 2.0 g/10 min., alternatively from 0.2 to 1.5 g/10 min., alternatively from 0.25 to 1.00 g/10 min., is not obtained by degrading (visbreaking) the polyolefin composition obtained from the polymerization reaction.

In some embodiments, the fraction soluble in xylene at 25° C. of the polyolefin composition (XS(tot)) has an intrinsic viscosity ranging from 2.0 to 5.5 dl/g, alternatively 2.5 to 4.5 dl/g, alternatively from 3.1 to 3.9 dl/g.

In some embodiments, the polyolefin composition is made from or containing 15-35% by weight, alternatively 20-30% by weight, of component (A) and 65-85% by weight, alternatively 70-80% by weight, of component (B), wherein the amounts of (A) and (B) are based on the total weight of (A)+(B).

In some embodiments, the polyolefin composition is made from or containing:
(A) 10-40% by weight, alternatively 15-35% by weight, alternatively 20-30% by weight, of a copolymer of propylene with hexene-1 made from or containing 1.0-6.0% by weight, based on the weight of component (A), alternatively 2.0-5.0% by weight, alternatively 2.8-4.8% by weight, alternatively 3.0-4.0% by weight, of hexene-1 and has a melt flow rate (MFR_{A}) measured according to ISO 1133, 230° C., 2.16 kg ranging from 20 to 60 g/10 min., alternatively from 25 to 55 g/10 min., alternatively from 30 to 50 g/10 min.; and
(B) 60-90% by weight, alternatively 65-85% by weight, alternatively 70-80% by weight, of a copolymer of propylene with ethylene made from or containing 20-35% by weight of ethylene, based on the total weight of component (B),
   wherein
   i) the polyolefin composition has an amount of fraction soluble in xylene at 25° C. (XS(tot)) higher than 65% by weight, alternatively higher than 70% by weight, alternatively ranging from 71 to 90% by weight, alternatively from 72 to 80% by weight;
   ii) the amounts of (A) and (B) and XS(tot) are based on the total weight of (A)+(B); and
   iii) the melt flow rate (MFR) measured according to ISO 1133, 230° C., 2.16 kg of the polyolefin composition ranges from 0.2 to 6.0 g/10 min., alternatively from 0.2 to 2.0 g/10 min., alternatively from 0.2 to 1.5 g/10 min., alternatively from 0.25 to 1.00 g/10 min.

In some embodiments, the polyolefin composition has one or more of the following properties:
Flexural Modulus ranging from 50 to 90 MPa, alternatively from 60 to 85 MPa, alternatively from 65 to 80 MPa, measured according to ISO 178:2019, on injection-molded specimens;
Charpy resistance at −40° C. equal to or higher than 6.0 KJ/m², measured according to ISO 179/1eA 2010;
tensile modulus lower than 70.0 MPa, alternatively lower than 60.0 MPa, alternatively lower than 50 MPa in MD or TD, alternatively in MD and TD, determined on 1 mm-thick extruded sheets according to the method ISO 527-3 (specimens type 2, Crosshead speed: 1 mm/min);
Strength at break greater than 14.0 MPa, alternatively greater than 15.0 MPa, in MD or TD, alternatively in MD and TD, determined on 1 mm-thick extruded sheets according to the method ISO527-3 (Specimens type: 5, Crosshead speed: 500 mm/min); and/or
puncture resistance greater than 170 N, alternatively greater than 200 N, measured on a 1 mm-thick extruded sheet according to method ASTM D 4833 (punch diameter: 8 mm, crosshead speed: 300 mm/min);
Shore A value lower than 90, measured on 1 mm-thick extruded sheets according to method ISO 868 (15 sec); or
Shore D value equal to or lower than 30, measured on 1 mm-thick extruded sheets according to method ISO 868 (15 sec). In some embodiments, the Charpy resistance at −40° C. is in the range 6.0-10.0 KJ/m². In some embodiments, the tensile modulus in MD or TD, alternatively in MD and TD, is in the range 30.0-70.0 MPa, alternatively 30.0-60.0 MPa. In some embodiments, the strength at break in MD or TD, alternatively in MD and TD, is in the range 14.0-20.0, alternatively 15.0-18.0. In some embodiments, the puncture resistance is in the range 170-250 N, alternatively 200-250 N. In some embodiments, the Shore A value is in the range 70-90. In some embodiments, the Shore D value is in the range 23-30.

In some embodiments, the polyolefin composition has Flexural Modulus, Charpy resistance at −40° C., Strength at Break, Tensile Modulus, Puncture Resistance, Shore A, and Shore D values in the ranges indicated above.

In some embodiments, the polyolefin composition has one or more of the following properties measured on injection-molded specimens:
Strength at break greater than or equal to 9.0 MPa, measured according to the method ISO 527;
Elongation at break, determined according to the method ISO 527, in the range 350-550%;
Vicat softening temperature, determined according to the method ISO 306 (A50), in the range 40° -60° C.;
Shore A value, determined according to the method ISO 868 (15 sec), in the range 70-90; or
Shore D value, determined according to the method ISO 868 (15 sec), in the range 23-30. In some embodiments, the strength at break is in the range 9.0-15.0 MPa.

In some embodiments, the polyolefin composition has one or more of the following properties, measured on 1 mm-thick extruded sheets:
Elongation at break in MD or TD, alternatively in MD and TD, determined according to the method ISO527-3 (Specimens type: 5, Crosshead speed: 500 mm/min), in the range 600-800%;
Tear resistance in MD or TD, alternatively in MD and TD, determined according to the method ASTM D 1004 (Crosshead speed: 51 mm/min; V-shaped die cut specimen), in the range 40-70 g, alternatively 50-65 g; or
puncture deformation greater than or equal to 40 mm, alternatively greater than or equal to 45 mm, measured according to method ASTM D 4833 (punch diameter: 8 mm, crosshead speed: 300 mm/min). In some embodiments, the puncture deformation is in the range 40-60 mm, alternatively 45-60 mm.

In some embodiments, the polyolefin composition has the properties described above.

In some embodiments, the properties are measured on injection-molded and extruded specimens obtained as described in the experimental section of the present disclosure.

In some embodiments, the polyolefin composition is prepared by sequential polymerization in two or more stages, wherein the second and each subsequent polymerization stage is carried out in the presence of the polymer produced in the immediately preceding polymerization stage.

In some embodiments, the polymerization processes to prepare the single components (A) and (B) or the sequential polymerization process to prepare the polyolefin composition are carried out in the presence of a catalyst selected from the group consisting of metallocene compounds, stereospecific Ziegler-Natta catalyst systems, and combinations thereof.

In some embodiments, the polymerization processes to prepare the single components (A) and (B) or the sequential polymerization process to prepare the polyolefin composition are carried out in the presence of a stereospecific Ziegler-Natta catalyst system made from or containing:

(1) a solid catalyst component made from or containing a magnesium halide support on which a Ti compound having at least a Ti-halogen bond is present, and a stereoregulating internal donor;

(2) optionally, an Al-containing cocatalyst; and

(3) optionally, a further electron-donor compound (external donor). In some embodiments, the stereospecific Ziegler-Natta catalyst system is further made from or containing the Al-containing cocatalyst. In some embodiments, the stereospecific Ziegler-Natta catalyst system is further made from or containing the electron-donor compound (external donor).

In some embodiments, the solid catalyst component (1) is made from or containing a titanium compound of formula Ti(OR)ₙX_{y_n}, wherein n is between 0 and y; y is the valence of titanium; X is halogen and R is a hydrocarbon group having 1-10 carbon atoms or a —COR group. In some embodiments, titanium compounds having a Ti-halogen bond is selected from the group consisting of titanium tetrahalides and titanium halogenalcoholates. In some embodiments, the titanium compounds are selected from the group consisting of TiCl₃, TiCl₄, Ti(OBu)₄, Ti(OBu)Cl₃, Ti(OBu)₂Cl₂, and Ti(OBu)₃Cl. In some embodiments, the titanium compound is TiCl₄.

In some embodiments, the solid catalyst component (1) is made from or containing a titanium compound in an amount providing from 0.5 to 10% by weight of Ti with respect to the total weight of the solid catalyst component (1).

In some embodiments, the solid catalyst component (1) is made from or containing a stereoregulating internal electron donor compound selected from mono or bidentate organic Lewis bases. In some embodiments, the solid catalyst component (1) is made from or containing a stereoregulating internal electron donor compound selected from the group consisting of esters, ketones, amines, amides, carbamates, carbonates, ethers, nitriles, alkoxysilanes, and combinations thereof.

In some embodiments, the electron donors are selected from the group consisting of aliphatic or aromatic mono- or dicarboxylic acid esters and diethers.

In some embodiments, the alkyl and aryl esters of optionally substituted aromatic polycarboxylic acids are selected from the group consisting of esters of phthalic acids. In some embodiments, the esters of phthalic acids are as described in European Patent Application Nos. EP45977A2 and EP395083A2.

In some embodiments, the internal electron donor is selected from the group consisting of mono- or di-substituted phthalates, wherein the substituents are independently selected from the group consisting of linear or branched C₁₋₁₀ alkyl, C₃₋₈ cycloalkyl and aryl radicals.

In some embodiments, the internal electron donor is selected from the group consisting of di-isobutyl phthalate, di-n-butyl phthalate, di-n-octyl phthalate, diphenyl phthalate, benzylbutyl phthalate, and combinations thereof.

In some embodiments, the internal electron donor is di-isobutyl phthalate.

In some embodiments, the esters of aliphatic acids are from malonic acids, glutaric acids, or succinic acids. In some embodiments, the esters of malonic acids are as described in Patent Cooperation Treaty Publication Nos. WO98/056830, WO98/056833, and WO98/056834. In some embodiments, the esters of glutaric acids are as described in Patent Cooperation Treaty Publication No. WO00/55215. In some embodiments, the esters of succinic acids are as described in Patent Cooperation Treaty Publication No. WO00/63261.

In some embodiments, the diesters are derived from esterification of aliphatic or aromatic diols. In some embodiments, the diesters are as described in Patent Cooperation Treaty Publication No. WO2010/078494 and U.S. Pat. No. 7,388,061.

In some embodiments, the internal electron donor is selected from 1,3-diethers of formula

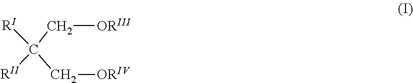

wherein R¹ and R¹¹ are independently selected from C₁₋₁₈ alkyl, C₃₋₁₈ cycloalkyl, and C⁷⁻¹⁸ aryl radicals, R^{III} and R^{IV} are independently selected from C₁₋₄ alkyl radicals; or the carbon atom in position 2 of the 1,3-diether belongs to a cyclic or polycyclic structure made up of from 5 to 7 carbon atoms, or of 5-n or 6-n′ carbon atoms, and respectively n nitrogen atoms and n′ heteroatoms selected from the group consisting of N, O, S and Si, where n is 1 or 2 and n′ is 1, 2, or 3, wherein the structure containing two or three unsaturations (cyclopolyenic structures), and optionally being condensed with other cyclic structures, or substituted with one or more substituents selected from the group consisting of linear or branched alkyl radicals; cycloalkyl, aryl, aralkyl, alkaryl radicals and halogens, or being condensed with other cyclic structures and substituted with one or more substituents, wherein one or more of the alkyl, cycloalkyl, aryl, aralkyl, or alkaryl radicals and the condensed cyclic structures optionally contain one or more heteroatom(s) as substitutes for carbon or hydrogen atoms. In some embodiments, the substituents are bonded to the condensed cyclic structures. In some embodiments, the ethers are as described in European Patent Application Nos. EP361493 and EP728769 and Patent Cooperation Treaty Publication No. WO02/100904.

In some embodiments, 1,3-diethers are used and the external electron donor (3) is absent.

In some embodiments, mixtures of internal donors are used. In some embodiments, the mixtures are between aliphatic or aromatic mono or dicarboxylic acid esters and 1,3-diethers as described in Patent Cooperation Treaty Publication Nos. WO07/57160 and WO2011/061134.

In some embodiments, the magnesium halide support is magnesium dihalide.

In some embodiments, the amount of internal electron donor which remains fixed on the solid catalyst component (1) is 5 to 20% by moles, with respect to the magnesium dihalide.

In some embodiments, preparation of the solid catalyst components involves a reaction of Mg dihalide precursors with titanium chlorides to form the Mg dihalide support. In some embodiments, the reaction is carried out in the presence of the stereoregulating internal donor.

In some embodiments, the magnesium dihalide precursor is a Lewis adduct of formula MgCl₂·nR1OH, wherein n is a number between 0.1 and 6, and R1 is a hydrocarbon radical having 1-18 carbon atoms. In some embodiments, n ranges from 1 to 5, alternatively from 1.5 to 4.5.

In some embodiments, the adduct is prepared by mixing alcohol and magnesium chloride, operating under stirring conditions at the melting temperature of the adduct (100-130° C.).

Then, the adduct is mixed with an inert hydrocarbon immiscible with the adduct, thereby creating an emulsion which is quickly quenched causing the solidification of the adduct in the form of spherical particles.

In some embodiments, the resulting adduct is directly reacted with the Ti compound or subjected to thermal controlled dealcoholation (80-130° C.), thereby obtaining an adduct wherein the number of moles of alcohol is lower than 3, alternatively between 0.1 and 2.5.

In some embodiments, this controlled dealcoholation step is carried out to increase the morphological stability of the catalyst during polymerization or to increase the catalyst porosity as described in European Patent Application No. EP395083A2.

In some embodiments, the reaction with the Ti compound is carried out by suspending the optionally-dealcoholated adduct in cold TiCl₄. In some embodiment, cold TiCl₄ is at 0° C.). In some embodiments, the mixture is heated up to 80-130° C. and kept at this temperature for 0.5-2 hours. In some embodiments, the treatment with TiCl₄ is carried out one or more times. In some embodiments, the stereoregulating internal donor is added during the treatment with TiCl₄. In some embodiments, the treatment with the internal donor is repeated one or more times.

In some embodiments, the preparation of catalyst components is as described in U.S. Pat. Nos. 4,399,054 and 4,469,648, Patent Cooperation Treaty Publication No. WO98/44009A1, and European Patent Application No. EP395083A2.

In some embodiments, the catalyst component (1) is in the form of spherical particles having an average diameter ranging from 10 to 350 μm, a surface area ranging from 20 to 250 m²/g, alternatively from 80 to 200 m²/g, and porosity greater that 0.2 ml/g, alternatively from 0.25 to 0.5 ml/g, wherein the surface area and the porosity are measured by BET.

In some embodiments, the catalyst system is made from or containing an Al-containing cocatalyst (2). In some embodiments, the Al-containing cocatalyst (2) is selected from the group consisting of Al-trialkyls, alternatively the group consisting of Al-triethyl, Al-triisobutyl, and Al-tri-n-butyl.

In some embodiments, the Al/Ti weight ratio in the catalyst system is from 1 to 1000, alternatively from 20 to 800.

In some embodiments, the catalyst system is further made from or containing electron donor compound (3) (external electron donor). In some embodiments, the external electron donor is selected from the group consisting of silicon compounds, ethers, esters, amines, heterocyclic compounds, and ketones. In some embodiments, the heterocyclic compound is 2,2,6,6-tetramethylpiperidine.

In some embodiments, the external donor is selected from the group consisting of silicon compounds of formula (R2)a(R3)bSi(OR4)c, where a and b are integers from 0 to 2, c is an integer from 1 to 4, and the sum (a+b+c) is 4; R2, R3, and R4, are alkyl, cycloalkyl, or aryl radicals with 1-18 carbon atoms, optionally containing heteroatoms. In some embodiments, a is 1, b is 1, c is 2, at least one of R2 and R3 is selected from branched alkyl, cycloalkyl or aryl groups with 3-10 carbon atoms, optionally containing heteroatoms, and R4 is a C1-C10 alkyl group. In some embodiments, R4 is a methyl group.

In some embodiments, the silicon compounds are selected from the group consisting of methylcyclohexyldimethoxysilane (C-donor), diphenyldimethoxysilane, methyl-t-butyldimethoxysilane, dicyclopentyldimethoxysilane (D-donor), diisopropyldimethoxysilane, (2-ethylpiperidinyl)t-butyldimethoxysilane, (2-ethylpiperidinyl)thexyldimethoxysilane, (3,3,3 -trifluoro-n-propyl)(2-ethylpiperidinyl)dimethoxysilane, methyl(3,3,3-trifluoro-n-propyl)dimethoxysilane, and combinations thereof.

In some embodiments, the silicon compounds are wherein a is 0, c is 3, R3 is a branched alkyl or cycloalkyl group, optionally containing heteroatoms, and R4 is methyl. In some embodiments, the silicon compounds are selected from the group consisting of cyclohexyltrimethoxysilane, t-butyltrimethoxysilane, and hexyltrimethoxysilane.

In some embodiments, the catalyst system is made from or containing di-isobutyl phthalate as internal electron donor and dicyclopentyl dimethoxy silane (D-donor) as external electron donor (3).

In some embodiments, the catalyst system is pre-contacted with small quantities of olefin (prepolymerization), maintaining the catalyst in suspension in a hydrocarbon solvent, and polymerizing at temperatures from 25° to 60° C., thereby producing a quantity of polymer from about 0.5 to about 3 times the weight of the catalyst system.

In some embodiments, the prepolymerization is carried out in liquid monomer, thereby producing a quantity of polymer 1000 times the weight of the catalyst system.

In some embodiments, sequential polymerization processes for preparing the polyolefin compositions are as described in European Patent Application No. EP472946 and Patent Cooperation Treaty Publication No. WO03/011962, which content is incorporated in this patent application.

In some embodiments, components (A) and (B) are produced in any of the polymerization stages.

In some embodiments, the polymerization process includes polymerizations stages carried out in the presence of a stereospecific Ziegler-Natta catalyst system, wherein:
(a) in the first copolymerization stage, monomers are polymerized to form the propylene copolymer (A); and
(b) in the second copolymerization stage, the relevant monomers are polymerized to form the propylene copolymer (B).

In some embodiments, the second copolymerization stage (b) includes a copolymerization stage (b1) and a copolymerization stage (b2), wherein the comonomers are polymerized to form propylene copolymer (B1) in stage (1)1) and propylene copolymer (B2) in stage (b2).

In some embodiments, the second copolymerization stage (b) includes a copolymerization stage (b1) and a copolymerization stage (b2), wherein propylene copolymer (B2) is formed in copolymerization stage (b1) and propylene copolymer (B1) is formed in copolymerization stage (b2).

In some embodiments, the polymerization is continuous or batch. In some embodiments, the polymerization is carried out according to cascade techniques, operating either in mixed liquid phase/gas phase or totally in gas phase.

In some embodiments, the liquid-phase polymerization is in slurry, solution, or bulk (liquid monomer). In some embodiments, the liquid-phase polymerization is carried out in various types of reactors. In some embodiments, the reactors are continuous stirred tank reactors, loop reactors, or plug-flow reactors.

In some embodiments, the gas-phase polymerization stages are carried out in gas-phase reactors. In some embodiments, the gas-phase reactors are fluidized or stirred, fixed bed reactors.

In some embodiments, the copolymerization stage (a) is carried out in liquid phase using liquid propylene as diluent and the copolymerization stage (b), or the copolymerization stages (b1) and (b2), are carried out in the gas phase.

In some embodiments, the copolymerization stage (a) is carried out in the gas phase.

In some embodiments, the reaction temperatures of the polymerization stages (a), (b), (b1), and (b2) are independently selected from values in the range from 40° to 90° C.

In some embodiments, the polymerization pressure of the copolymerization stage (a) carried out in liquid phase is from 3.3 to 4.3 MPa.

In some embodiments, the polymerization pressure of the copolymerization stages (a), (b), (b1), and (b2) carried out in gas-phase is independently selected from values in the range from 0.5 to 3.0 MPa.

In some embodiments, the residence time of each polymerization stage depends upon the ratio of components (A) and (B), or of components (A), (B1), and (B2), of the polyolefin composition.

In some embodiments, the residence time in each polymerization stage ranges from 15 minutes to 8 hours.

In some embodiments, the polyolefin composition is prepared by a sequential polymerization process and the amounts of components (A) and (B), or of components (A), (B1), and (B2), correspond to the split between the polymerization reactors.

In some embodiments, the molecular weight of the propylene copolymers obtained in the polymerization stages is regulated using chain transfer agents. In some embodiments, the chain transfer agent is hydrogen or ZnEt₂

In some embodiments, the polyolefin composition is blended with additives at the end of the polymerization reaction.

In some embodiments, the polyolefin composition is an additive-containing polyolefin composition (AD1) made from or containing a total amount up to 0.3% by weight, based on the total weight of the additive-containing polyolefin composition (AD1), alternatively from 0.01 to 0.3% by weight, of a first additive (C) selected from the group consisting of antistatic agents, anti-oxidants, anti-acids, melt stabilizers, and combinations thereof.

In some embodiments, the polyolefin composition is an additive-containing polyolefin composition (AD1) consisting of component (A), component (B), and the first additive (C).

In some embodiments, the polyolefin composition is further made from or containing a second additive (D) selected from the group consisting of fillers, pigments, nucleating agents, extension oils, flame retardants, UV resistant additives, UV stabilizers, lubricants, antiblocking agents, waxes, coupling agents for fillers, and combinations thereof. In some embodiments, the flame retardant is aluminum trihydrate. In some embodiments, the UV resistant additive is titanium dioxide. In some embodiments, the lubricant is oleamide.

In some embodiments, the additive-containing polyolefin composition is made from or containing up to 50% by weight, alternatively from 0.01 to 50% by weight, alternatively from 0.5 to 30% by weight, of the second additive (D), wherein the amount of the second additive (D) being based the total weight of the polyolefin composition made from or containing the second additive (D).

In some embodiments, the polyolefin composition is an additive-containing polyolefin composition (AD2) made from or containing:
component (A);
component (B);
up to 0.3% by weight, alternatively 0.01-0.3% by weight, of a first additive, component (C); and
up to 50% by weight, alternatively from 0.01 to 50% by weight, alternatively from 0.5 to 30% by weight, of a second additive, component (D),
wherein the amounts are components (A) and (B) are based on the total weight of (A)+(B) and the amount of the first additive component (C) and the second additive component (D) are based on the total weight of the additive-containing polyolefin composition (AD2).

In some embodiments, the first additive component (C) and the second additive component (D) are selected from the groups described above.

In some embodiments, the additive-containing polyolefin composition (AD2) consists of components (A), (B), (C), and (D).

In some embodiments, the present disclosure provides a sheet or membrane made from or containing the polyolefin composition.

In some embodiments, the sheet or membrane is made from or containing the additive-containing polyolefin (AD1) or the additive-containing polyolefin composition (AD2).

In some embodiments, the sheet or membrane has total thickness in the range from 1000 to 2000 μm, alternatively from 1200 to 1800 μm.

In some embodiments, the sheet or membrane is a monolayer or a multilayer sheet or membrane.

In some embodiments, the sheet or membrane is a monolayer sheet or membrane made from or containing the polyolefin composition, the additive-containing polyolefin composition (AD1), or the additive-containing polyolefin composition (AD2).

In some embodiments, the monolayer sheet or membrane consists of the polyolefin composition, or the additive-containing polyolefin composition (AD1), or the additive-containing polyolefin composition (AD2).

In some embodiments, the sheet or membrane is a multilayer sheet or membrane made from or containing a layer X, wherein the layer X is made from or containing the polyolefin composition, the additive-containing polyolefin composition (AD1), or the additive-containing polyolefin composition (AD2).

In some embodiments, the layer X consists of the polyolefin composition, the additive-containing polyolefin composition (AD1), or the additive-containing polyolefin composition (AD2).

In some embodiments, the multilayer sheet or membrane is made from or containing a layer X and a layer Y, wherein the layer X and the layer Y are made from or containing a polyolefin independently selected from the group consisting of the polyolefin composition, the additive-containing polyolefin composition (AD1), and the additive-containing polyolefin composition (AD2).

In some embodiments, the multilayer sheet or membrane is made from or containing a layer X and a layer Y, wherein the layer X and the layer Y consist of a polyolefin independently selected from the group consisting of the polyolefin composition, the additive-containing polyolefin composition (AD1), and the additive-containing polyolefin composition (AD2).

In some embodiments, the multilayer sheet or membrane consists of a layer X and a layer Y, wherein the layer X and the layer Y are made from or containing a polyolefin independently selected from the group consisting of the polyolefin composition, the additive-containing polyolefin composition (AD1), and the additive-containing polyolefin composition (AD2).

In some embodiments, the multilayer sheet or membrane consists of a layer X and a layer Y, wherein the layer X and the layer Y consist of a polyolefin independently selected from the group consisting of the polyolefin composition, the additive-containing polyolefin composition (AD1), and the additive-containing polyolefin composition (AD2).

In some embodiments, the multilayer sheet or membrane is made from or containing layers X, Y, and Z, and has layers' structure X/Z/Y, wherein layer X and layer Y are as described above, and layer Z is a reinforcing layer made from or containing a plastic material selected from the group consisting of propylene homopolymers, propylene copolymers, polyethylene, polyethylene terephthalate, and combinations thereof.

In some embodiments, the layer Z is a woven fabric or a non-woven fabric.

In some embodiments, the monolayer sheets or membranes are obtained by calendaring, extrusion, or spread coating. In some embodiments, the monolayer sheet or membrane is obtained by extrusion.

In some embodiments, multilayer sheets or membranes are obtained by co-extrusion of the polyolefin in the layers or by lamination of the layers.

In some embodiments, the sheet or membrane is a single-ply roofing sheet or membrane.

In some embodiments, the sheet or membrane is a geomembrane.

The features describing the subject matter of the present disclosure are not inextricably linked to each other. Accordingly, a level of a first feature does not necessarily involve the same level of additional features. The present disclosure supports selection of any combination of the parametric ranges and/or features, even though the combination may not be explicitly described herein.

### EXAMPLES

The following examples are illustrative and not intended to limit the scope of the disclosure in any manner whatsoever.

### Characterization Methods

The following methods are used to determine the properties indicated in the description, claims and examples.

Melt Flow Rate: Determined according to the method ISO 1133 (230° C., 2.16 kg).

Solubility in xylene at 25° C.: 2.5 g of polymer sample and 250 ml of xylene were introduced into a glass flask equipped with a refrigerator and a magnetic stirrer. The temperature was raised in 30 minutes up to 135° C. The resulting clear solution was kept under reflux and stirred for further 30 minutes. The solution was cooled in two stages. In the first stage, the temperature was lowered to 100° C. in air for 10 to 15 minutes under stirring. In the second stage, the flask was transferred to a thermostatically-controlled water bath at 25° C. for 30 minutes. The temperature was lowered to 25° C. without stirring during the first 20 minutes and maintained at 25° C. with stirring for the last 10 minutes. The formed solid was filtered on quick filtering paper (for example, Whatman filtering paper grade 4 or 541). 100 ml of the filtered solution (S1) was poured into a pre-weighed aluminum container, which was heated to 140° C. on a heating plate under nitrogen flow, thereby removing the solvent by evaporation. The container was then kept in an oven at 80° C. under vacuum until constant weight was reached. The amount of polymer soluble in xylene at 25° C. was then calculated. XS(tot) and XS_{A} values were experimentally determined. The fraction of component (B) soluble in xylene at 25° C. (XS_{B}) was calculated from the formula:

XS=W(A)×(XS_{A})+W(B)×(XS_{B})

wherein W(A) and W(B) are the relative amounts of components (A) and (B), respectively, and W(A)+W(B)=1.

Intrinsic viscosity of the xylene soluble fraction: to calculate the value of the intrinsic viscosity IV, the flow time of a polymer solution was compared with the flow time of the solvent tetrahydronaphthalene (THN). A glass capillary viscometer of Ubbelohde type was used. The oven temperature was adjusted to 135° C. Before starting the measurement of the solvent flow time to, the temperature was stable (135°±0.2° C.). Sample meniscus detection for the viscometer was performed by a photoelectric device.

Sample preparation: 100 ml of the filtered solution (51) was poured into a beaker, and 200 ml of acetone were added under vigorous stirring. Precipitation of insoluble fraction was complete as evidenced by a clear solid-solution separation. The suspension was filtered on a weighed metallic screen (200 mesh). The beaker was rinsed. The precipitate was washed with acetone, thereby removing the o-xylene. The precipitate was dried in a vacuum oven at 70° C. until a constant weight was reached. 0.05g of precipitate were dissolved in 50 ml of tetrahydronaphthalene (THN) at a temperature of 135° C. The efflux time t of the sample solution was measured and converted into a value of intrinsic viscosity [η] using Huggins' equation (Huggins, M. L., J. Am. Chem. Soc. 1942, 64, 11, 2716-2718) and the following data:
concentration (g/dl) of the sample;
the density of the solvent at a temperature of 135° C.;
the flow time t0 of the solvent at a temperature of 135° C. on the same viscometer.
   A single polymer solution was used to determine [ii].

Comonomer content: determined by IR using Fourier Transform Infrared Spectrometer (FTIR). The spectrum of a pressed film of the polymer was recorded in absorbance vs. wavenumbers (cm⁻¹). The following measurements was used to calculate ethylene and hexene-1 content:
Area (At) of the combination absorption bands between 4482 and 3950 cm⁻¹, was used for spectrometric normalization of film thickness;
a linear baseline was subtracted in the range 790-660 cm⁻¹ and the remaining constant offset was eliminated; and
the contents of ethylene and hexene-1 were obtained by applying a Partial Least Square (PLS1) multivariate regression to the 762-688 cm⁻¹ range.
   The method was calibrated by using polymer standards based on ¹³C NMR analyses.
   Sample preparation: Using a hydraulic press, a thick sheet was obtained by pressing about 1 g of sample between two aluminum foils. Pressing temperature was 180±10° C. (356° F.), and about 10 kg/cm² pressure was applied for about one minute (minimum two pressing operations for each specimen). A small portion was cut from the sheet to mold a film. The film thickness was between 0.02-0.05 cm.

Injection-molded specimens: test specimens 80×10×4 mm were obtained according to the method ISO 1873-2:2007.

Flexural modulus: Determined according to the method ISO 178:2019 on injection-molded test specimens.

Strength and Elongation at break: Determined according to the method ISO 527 on injection-molded test specimens.

Shore A and D on injection-molded specimens: Determined according to the method ISO 868 (15 sec).

Vicat softening temperature: Determined according to the method ISO 306 (A50) on injection-molded specimens.

Charpy Impact test at −40° C.: measured according to ISO 179/1eA 2010 on injection-molded specimens.

Preparation of extruded specimens: the polymer, in form of granules, was fed via feed hoppers into a Leonard extruder (mono-screw extruder, 40 mm in diameter and 27 L/D in length) wherein the polymer was melted (melt temperature 230° C.), compressed, mixed, and metered out at a throughput rate of 10 Kg/h with a metering pump (15 cc/rpm). The molten polymer left the flat die (width 200 mm, die lip at 0.8-0.9 mm) and was instantly cooled through a vertical three-rolls calender having roll-temperature of 60° C. 1 mm-thick extruded sheets were obtained.

Tensile Modulus (MD and TD): Determined according to the method ISO 527-3 on 1 mm-thick extruded sheets. Specimens type 2, Crosshead speed: 1 mm/min.

Tensile strength and elongation at break (MD and TD): Determined according to the method ISO527-3 on 1 mm-thick extruded sheets. Specimens type: 5, Crosshead speed: 500 mm/min.

Tear resistance: Determined according to the method ASTM D 1004 on 1 mm-thick extruded sheets. Crosshead speed: 51 mm/min; V-shaped die cut specimen.

Puncture resistance and deformation: Determined according to the method ASTM D 4833 on 1 mm-thick extruded sheets. Punch diameter 8 mm, crosshead speed: 300 mm/min.

Shore A and D on extruded sheets: Determined according to the method ISO 868 (15 sec) on 1 mm-thick extruded sheets.

### Examples 1-2 and Comparative example 3

The polymerization was carried out in two gas phase reactors connected in series and equipped with devices to transfer the product from the first reactor to the second reactor. For the polymerization, a Ziegler-Natta catalyst system was used made from or containing:
a titanium-containing solid catalyst component prepared as described in European Patent Application No. EP395083, Example 3, according to which di-isobutyl phthalate was used as internal electron donor compound;
triethylaluminium (TEAL) as co-catalyst; and
Dicyclopentyl dimethoxy silane (DCPMS) as external electron donor.

The solid catalyst component was contacted with TEAL and DCPMS in a pre-contacting vessel, with a weight ratio of TEAL to the solid catalyst component of 4-5. The weight ratio TEAL/DCPMS (T/D) is reported in Table 1.

The catalyst system was then subjected to pre-polymerization by suspending the catalyst system in liquid propylene at 20° C. for about 30-32 minutes before introducing the catalyst system into the first polymerization reactor.

Propylene copolymer (A) was produced into the first gas phase reactor by feeding, in a continuous and constant flow, the pre-polymerized catalyst system, hydrogen (used as molecular weight regulator) and propylene and comonomer (hexene-1 or ethylene), in gaseous phase.

The propylene copolymer (A) coming from the first reactor was discharged in a continuous flow and, after having been purged of unreacted monomers, was introduced, in a continuous flow, into the second gas phase reactor, together with quantitatively constant flows of propylene, ethylene and hydrogen, in the gas state. In the second reactor, the propylene copolymer (B) was produced.

Polymerization conditions, molar ratio of the reactants, and composition of the copolymers obtained are shown in Table 1.

TABLE 1
polymerization conditions

| | | |
|---|---|---|
| | | Comp. |
| Ex. 1 | Ex. 2 | Ex. 3 |

GPR 1—component A

| | | | | |
|---|---|---|---|---|
| T/D | | 5 | 10 | 5 |
| Temperature | ° C. | 60 | 60 | 70 |
| Pressure | barg | 18 | 16 | 18 |
| H₂/C₃_{^{−}} | mol. | 0.13 | 0.06 | 0.10 |
| C₆_{^{−}}/(C₆_{^{−}} + C₃_{^{−}}) | mol | 0.031 | 0.030 | / |
| C₂_{^{−}}/(C₂_{^{−}} + C₃_{^{−}}) | mol | / | / | 0.01 |
| Split | wt % | 21 | 22 | 31 |
| Xylene soluble of A (XS_{A}) | wt % | 6.2 | 6.2 | 5.5 |
| MFR of A (MFR_{A}) | g/10 min. | 45 | 29 | 25 |
| C₆_{^{−}} content of A | wt % | 3.5 | 3.5 | / |
| C₂_{^{−}} content of A | wt % | / | / | 3.2 |

GPR 2—Component B

| | | | | |
|---|---|---|---|---|
| Temperature | ° C. | 60 | 55 | 60 |
| Pressure | barg | 18 | 16 | 18 |
| H₂/C₂_{^{−}} | mol. | 0.072 | 0.069 | 0.09 |
| C₂_{^{−}}/(C₂_{^{−}} + C₃_{^{−}}) | mol. | 0.17 | 0.16 | 0.16 |
| Split | wt % | 79 | 78 | 69 |
| C₂_{^{−}} content of B * | wt % | 27 | 27 | 27 |
| C₂_{^{−}} content of (A + B) | wt % | 20.9 | 21.1 | 19.4 |
| Xylene soluble of (A + B) | wt % | 75.0 | 71.2 | 63.3 |
| (XS(tot)) | | | | |
| Intrinsic viscosity of (A + B) | dl/g | 3.7 | 3.4 | 3.18 |
| (XSIV) | | | | |
| MFR of (A + B) | g/10 min | 0.27 | 0.33 | 0.61 |

Notes:
C₂_{^{−}} = ethylene in gas phase (IR);
C₃_{^{−}} = propylene in gas phase (IR);
C₆⁻ = hexene-1 in gas phase (IR);
split = amount of polymer produced in the concerned reactor.
* Calculated values.

The polymer particles exiting the second reactor were subjected to a steam treatment, thereby removing the unreacted monomers and volatile compounds, and then dried.

The resulting polyolefin composition was mixed with additives (C) in a twin screw extruder Berstorff ZE 25 (length/diameter ratio of screws: 34) and extruded under nitrogen atmosphere in the following conditions:

Rotation speed: 250 rpm;

Extruder output: 15 kg/hour;

Melt temperature: 245° C.

The additives were:
0.1% by weight of Irganox® 1010;
0.1% by weight of Irgafos® 168; and
0.05% by weight of DHT-4A®,

wherein the amounts of additives are referred to the total weight of the polyolefin composition containing the additives (C).

Irganox® 1010 is 2,2-bis[3-[,5-bis(1,1-dimethylethyl)-4-hydroxyphenyl]-1-oxopropoxy]methyl]-1,3-propanediyl-3,5-bis(1,1-dimethylethyl)-4-hydroxybenzene-propanoate; Irgafos® 168 is tris(2,4-di-tert.-butylphenyl)phosphite; DHT-4A® is Magnesium Aluminum Carbonate Hydroxide (hydrate).

Properties of the materials tested on injection-molded specimens are reported in Table 3. Properties of the material tested on extruded sheets are reported in Table 4.

### Comparative example 4

Using the same catalyst system as for example 1, a polyolefin composition was prepared in three gas phase reactors connected in series and equipped with devices to transfer the product between the reactors.

Propylene copolymer (A) was produced into the first gas phase reactor by feeding, in a continuous and constant flow, the pre-polymerized catalyst system, hydrogen (used as molecular weight regulator), propylene, and ethylene, in gaseous phase. The propylene copolymer (A) coming from the first reactor was discharged, in a continuous flow, and, after having been purged of unreacted monomers, introduced, in a continuous flow, into the second gas phase reactor, together with quantitatively constant flows of hydrogen and ethylene, in the gas state. In the second reactor, the propylene copolymer (B1) was produced. The product coming from the second reactor was discharged, in a continuous flow, and, after having been purged of unreacted monomers, introduced, in a continuous flow, into the third gas phase reactor, together with quantitatively constant flows of hydrogen, ethylene and propylene, in the gas state. In the third reactor, an ethylene-propylene polymer (B2) was produced.

Polymerization conditions, molar ratios of the reactants and composition of the copolymers obtained are shown in Table 2.

TABLE 2
polymerization conditions

Comp.
Ex. 4

GPR 1—component A

| | | |
|---|---|---|
| T/D | | 5 |
| Temperature | ° C. | 60 |
| Pressure | barg | 18 |
| H₂/C₃_{^{−}} | mol. | 0.04 |
| C₂_{^{−}}/(C₂_{^{−}} + C₃_{^{−}}) | mol | 0.030 |
| Split | wt % | 21 |
| Xylene soluble of A (XS_{A}) | wt % | <8.0 |
| MFR of A (MFR_{A}) | g/10 min. | 5.5 |
| C₂_{^{−}} content of A | wt % | 3.2 |

GPR 2—component B1

| | | |
|---|---|---|
| Temperature | ° C. | 64 |
| Pressure | barg | 18 |
| H₂/C₂_{^{−}} | mol. | 0.015 |
| C₂_{^{−}}/(C₂_{^{−}} + C₃_{^{−}}) | mol. | 0.16 |
| Split | wt % | 49 |
| C₂_{^{−}} content of B1* | wt % | 26 |
| C₂_{^{−}} content of (A + B1) | wt % | 19.4 |
| Xylene soluble of (A + B1) | wt % | 63.3 |
| Intrinsic viscosity (A + B1) | wt % | 4.80 |
| MFR of (A + B1) | g/10 min. | 0.61 |

GPR 3—component B2

| | | |
|---|---|---|
| Temperature | ° C. | 60 |
| Pressure | barg | 18 |
| H₂/C₂_{^{−}} | mol. | 0.009 |
| C₂_{^{−}}/(C₂_{^{−}} + C₃_{^{−}}) | mol. | 0.21 |
| Split | wt % | 30 |
| C₂_{^{−}} content of B2* | wt % | 40 |
| C₂_{^{−}} content of (A + B1 + B2) | wt % | 25.5 |
| Xylene soluble of (A + B1 + B2) (XS(tot)) | wt % | 73.0 |
| Intrinsic viscosity (A + B1 + B2) (XSIV) | dl/g | 5.50 |
| MFR of (A + B1 + B2) | g/10 min. | <0.1 |

Notes:
C₂_{^{−}} = ethylene in gas phase (IR);
C₃_{^{−}} = propylene in gas phase (IR);
split = amount of polymer produced in the concerned reactor.
*Calculated values.

The polymer particles exiting the third reactor were subjected to a steam treatment, thereby removing the unreacted monomers and volatile compounds, dried and melt-mixed with additives as described in example 1.

Properties of the materials tested on injection molded specimens are reported in Table 3. Properties of the material tested on extruded sheets are reported in Table 4.

TABLE 3
characterization on injection molded specimens

| | | | | Comp. | Comp. |
|---|---|---|---|---|---|
| | | Ex. 1 | Ex. 2 | Ex. 3 | Ex.4 |
| MFR | g/10 min | 0.27 | 0.33 | 0.61 | 0.65(**) |
| Flexural Modulus | MPa | 69 | 70 | 99 | 46 |
| Strength at break | MPa | 9.7 | 10.1 | 10.5 | 9.9 |
| Elongation at break | % | 379 | 390 | 400 | 505 |
| Vicat temperature | ° C. | 52 | 54 | 62 | 46 |
| (9.81 N) | | | | | |
| Charpy Resistance | KJ/m² | 6.8 | 7.0 | 5.2 | 5.2 |
| −40° C. | | | | | |
| Shore A | | 82 | 89 | >90 | 79 |
| Shore D | | 27 | 30 | 31 | <20 |

(**) the polyolefin was cracked with 170 ppm of peroxide, thereby increasing the MFR and rendering the polyolefin processable with extruders used in producing sheets or membranes.

TABLE 4
characterization on extruded sheets

| | | | | Comp. | Comp. |
|---|---|---|---|---|---|
| | | Ex. 1 | Ex. 2 | Ex. 3 | Ex. 4 |
| MFR | g/10 min | 0.27 | 0.33 | 0.61 | 0.65(**) |
| Tensile Modulus MD | MPa | 46 | 68 | 74 | 46 |
| Strength at break MD | MPa | 16.3 | 16.4 | 20.0 | 12.2 |
| Elongation at break MD | % | 710 | 650 | 760 | 690 |
| Tensile modulus TD | MPa | 39 | 58 | 71 | 32 |
| Strength at break TD | MPa | 18.3 | 18.0 | 20.2 | 12.1 |
| Elongation at break TD | % | 750 | 700 | 820 | 711 |
| Tear Resistance MD | g | 60 | 61 | 70 | 50 |
| Tear resistance TD | g | 59 | 61 | 70 | 46 |
| Puncture resistance | N | 212 | 235 | 241 | 165 |
| Puncture deformation | mm | 48 | 50 | 48 | 48 |
| Shore A | | 84 | 88 | >90 | 80 |
| Shore D | | 27 | 30 | 34 | 24 |

(**) the polyolefin was cracked with 170 ppm of peroxide, thereby increasing the MFR and rendering the polyolefin processable with extruders for producing sheets or membranes.

1. A polyolefin composition comprising:
(A) 10-40% by weight of a copolymer of propylene with hexene-L comprising 1.0-6.0% by weight, based on the weight of (A), of units deriving from hexene-1 and having a melt flow rate (MFR_{A}) measured according to ISO 1133, 230° C., 2.16 kg ranging from 20 to 60 g/10 min.; and
(B) 60-90% by weight of a copolymer of propylene with an alpha-olefin of formula CH₂═CHR, and optionally a diene, wherein R is H or a linear or branched C₂-C₈ alkyl and wherein the copolymer comprises 20-35% by weight, based on the total weight of (B), of alpha-olefin,
wherein
the polyolefin composition has an amount of fraction soluble in xylene (XS(tot)) at 25° C. equal to or higher than 65% by weight, and
the amounts of (A), (B), and XS(tot) being based on the total weight of (A)+(B).

2. The polyolefin composition of claim 1, wherein the propylene copolymer (A) comprises 2.0-5.0% by weight, based on the weight of component (A), of hexene-1.

3. The polyolefin composition of claim 1, wherein the propylene copolymer (A) has a melt flow rate (MFR_{A})—measured according to ISO 1133, 230° C., 2.16 kg ranging from 25 to 55 g/10 min.

4. The polyolefin composition according to claim 1, wherein the propylene copolymer (A) has an amount of fraction soluble in xylene at 25° C. (XS_{A}) lower than 12.0% by weight, based on the weight of component (A).

5. The polyolefin composition according to claim 1, having an amount of fraction soluble in xylene (XS(tot)) at 25° C. higher than 70% by weight, based on the total weight of (A)+(B).

6. The polyolefin composition according to claim 1, having a melt flow rate (MFR) measured according to ISO 1133, 230° C., 2.16 kg, ranging from 0.2 to 6.0 g/10 min.

7. The polyolefin composition according to claim 1, wherein the fraction soluble in xylene at 25° C. (XS(tot)) has an intrinsic viscosity ranging from 2.0 to 5.5 dl/g.

8. The polyolefin composition according to claim 1, wherein copolymer the alpha-olefin of copolymer (B) is selected from the group consisting of ethylene, butene-1, hexene-1, 4-methy-pentene-1, octene-h and combinations thereof.

9. The polyolefin composition according to claim 1, comprising:
(A) 10-40% by weight of a copolymer of propylene with hexene-1 comprising 1.0-6.0% by weight, based on the weight of component (A), of hexene-1 and having a melt flow rate (MFR_{A}) measured according to ISO 1133, 230° C., 2.16 kg ranging from 20 to 60 g/10 min.; and
(B) 60-90% by weight of a copolymer of propylene with ethylene comprising 20-35% by weight of ethylene, based on the total weight of component (B),
wherein
i) the polyolefin composition has an amount of fraction soluble in xylene at 25° C. (XS(tot)) higher than 65% by weight;
ii) the amounts of (A), (B), and XS(tot) are based on the total weight of (A)+(B); and
iii) the melt flow rate (MFR) measured according to ISO 1133, 230° C., 2.16 kg of the polyolefin composition ranges from 0.2 to 6.0 g/10 min.

10. The polyolefin composition according to claim 1, having at least one or more of the following properties:
Flexural Modulus ranging from 50 to 90 MPa, measured according to ISO 178:2019 on injection-molded specimens;
Charpy resistance at −40° C. equal to or higher than 6.0 KJ/m², measured according to ISO 179/1eA 2010;
tensile modulus lower than 70.0 MPa in MD or TD, determined on 1 mm-thick extruded sheets according to the method ISO 527-3 (specimens type 2, Crosshead speed: 1 mm/min);
Strength at break greater than 14.0 MPa in MD or TD, determined on 1 mm-thick extruded sheets according to the method ISO527-3 (Specimens type: 5, Crosshead speed: 500 mm/min);
puncture resistance greater than 170 N, measured on a 1 mm-thick extruded sheet according to method ASTM D 4833 (punch diameter: 8 mm, crosshead speed: 300 mm/min);
Shore A value lower than 90, measured on 1 mm-thick extruded sheets according to method ISO 868 (15 sec); or
Shore D value equal to or lower than 30, measured on 1 mm-thick extruded sheets according to method ISO 868 (15 sec).

11. A sheet or membrane comprising the polyolefin composition according to claim 1.

12. The sheet or membrane according to claim 11, wherein the sheet or membrane comprises layers X, Y, and Z, and has layers' structure X/Z/Y, wherein the layer X and the layer Y comprise the polyolefin composition, and the layer Z is a reinforcing layer comprising a plastic material selected from the group consisting of propylene homopolymers, propylene copolymers, polyethylene, polyethylene terephthalate and combinations thereof.

13. The sheet or membrane according to claim 12, wherein the layer Z is a woven or a non-woven fabric.

14. The sheet or membrane according to claim 11, being a single-ply roofing sheet or membrane.

15. The sheet or membrane according to claim 11, being a geomembrane.
